(19) United States
(12) Patent Application Publication
(10) Pub. No.: US 2024/0235678 A1
(43) Pub. Date: Jul. 11, 2024

(54) DEVICE FOR CONTROLLING THE TRANSMISSION/RECEIPT OF AN ACCESS POINT OF AN OPTICAL WIRELESS NETWORK

(71) Applicant: OLEDCOMM, VÉLIZY-VILLACOUBLAY (FR)

(72) Inventors: Carlos DOMINGUEZ-GONZALEZ, VÉLIZY-VILLACOUBLAY (FR); Clément LARTIGUE, VÉLIZY-VILLACOUBLAY (FR)

(21) Appl. No.: 18/570,414

(22) PCT Filed: Jun. 14, 2022
(86) PCT No.: PCT/IB2022/055496

§ 371 Date: Dec. 14, 2023

(30) Foreign Application Priority Data
Jun. 15, 2021 (FR) FR2106322

(51) Int. Cl. H04B 10/114; H04B 10/116

(52) U.S. Cl. CPC H04B 10/1143; H04B 10/116

(57) ABSTRACT

A control device is provided in an access point including an input/output interface connected to a communication bus using a communication protocol, a transmitting stage for converting a first signal from the input/output interface into a transmitted light signal, and a receiving stage for converting a received light signal into a second signal passed on to the input/output interface. This control device is arranged either to disable the receiving stage when the input/output interface receives a first signal from the communication bus, and to enable the receiving stage when the input/output interface no longer receives a first signal from the communication bus, or to disable the transmitting stage when the receiving stage receives a light signal, and to enable the transmitting stage when the receiving stage no longer receives a light signal.

The present invention relates to a control device intended to be provided in an access point of an optical wireless communication network.

Some optical wireless communication (OWC) networks, possibly of the LiFi (“Light Fidelity”) type, comprise a communication bus to which access points are connected. These access points enable communication equipment (such as cell phones (possibly smartphones), electronic tablets, or computers (possibly laptops)), coupled to OWC interface equipment (generally accessories (or “dongles”)), to communicate by means of intensity- and/or frequency-modulated light signals representative of data.

In this type of OWC network, each access point comprises an input/output interface connected to the communication bus, a transmitting stage suitable for converting a signal from the input/output interface into a transmitted light signal, and a receiving stage suitable for converting a received light signal into a signal which is communicated to the input/output interface.

Since all access points connected to the same communication bus must be able to communicate with each other one after the other, the greater the number of access points, the greater the sensitivity of their receiving stage must be (typically between −30 dB and −40 dB in the presence of more than twenty access points). As a result of this high sensitivity of the receiving stage, the light signal emitted by the receiving stage of an access point may be received a little later by the transmitting stage of the same access point, following at least one reflection (against a surface, for example). In this case, the data contained in the light signal received by an access point after reflection(s) returns to the communication bus via this same access point, and will therefore be retransmitted by the latter, which generates disturbances on the frame and can render the communication bus inoperative, since the same data can loop a large number of times, or even infinitely, at the same access point, and this loop can only be interrupted by physically cutting the optical link between the receiving and transmitting stages.

It may therefore be desirable to provide a control device which avoids at least part of the above-mentioned disadvantage.

In particular, a control device is proposed for equipping an access point comprising an input/output interface connected to a communication bus using a communication protocol, a transmitting stage suitable for converting a first signal from the input/output interface into a transmitted light signal, and a receiving stage suitable for converting a received light signal into a second signal passed on to the input/output interface.

This control device is characterized by the fact that it is arranged either to disable the receiving stage when the input/output interface receives a first signal from the communication bus, and to enable the receiving stage when the input/output interface no longer receives a first signal from the communication bus, or to disable the transmitting stage when the receiving stage receives a light signal, and to enable the transmitting stage when the receiving stage no longer receives a light signal.

This limits, or even prevents, the probability of loops and therefore disturbances to communication bus operation.

The control device according to the invention may comprise other features which may be taken separately or in combination, and in particular:
in a first embodiment, in the presence of an access point comprising a transmitting stage including a transmitting optoelectronic module suitable for converting a digital signal derived from a first signal into a light signal, and a receiving stage including a receiving optoelectronic module suitable for converting a received light signal into a digital signal representative of a second signal, it can be arranged either to disable the receiving optoelectronic module when the input/output interface receives a first signal from the communication bus, and to enable the receiving optoelectronic module when the input/output interface no longer receives a first signal from the communication bus, or to disable the transmitting optoelectronic module when the receiving stage receives a light signal, and to enable the transmitting optoelectronic module when the receiving stage no longer receives a light signal;
in this first embodiment, in the presence of an access point comprising a transmitting stage including a first conditioning module interposed between the input/output interface and the transmitting optoelectronic module and suitable for shaping the first signal so that it is compatible with a voltage level admissible by the transmitting optoelectronic module, and a receiving stage comprising a second conditioning module interposed between the receiving optoelectronic module and the input/output interface and suitable for shaping the digital signal supplied by the receiving optoelectronic module so that the resulting second signal can be interpreted on the communication bus, it may comprise a first signal detector arranged to detect each first signal in the first conditioning module and to enable/disable the receiving optoelectronic module, and a second signal detector arranged to detect each digital signal supplied by the receiving optoelectronic module in the second conditioning module and to enable/disable the transmitting optoelectronic module. For example, the first and second signal detectors may each comprise a monostable multivibrator;
alternatively, it may comprise a controller arranged to detect each first signal and each digital signal, and to enable/disable the transmitting stage and receiving stage. In this case, the controller may, for example, be arranged to enable/disable the transmitting optoelectronic module and receiving optoelectronic module;
in a second embodiment, it can be arranged to introduce into the transmitting stage a first time offset of each first signal greater than or equal to a first duration required for disabling the receiving stage and compatible with the communication protocol, and to introduce into the receiving stage a second time offset of each second signal before it reaches the input/output interface, this second time offset being greater than a second duration required for disabling the transmitting stage and compatible with the communication protocol;
in this second embodiment, in the presence of an access point comprising a transmitting stage including an transmitting optoelectronic module suitable for converting a digital signal derived from a first signal into a light signal and a first conditioning module interposed between the input/output interface and the transmitting optoelectronic module and suitable for shaping the first signal so that it is compatible with a voltage level admissible by the transmitting optoelectronic module, and a receiving stage comprising a receiving optoelectronic module suitable for converting a received light signal into a digital signal representative of a second signal, and a second conditioning module interposed between the input/output interface and the receiving optoelectronic module and suitable for shaping the digital signal supplied by the receiving optoelectronic module so that the resulting second signal can be interpreted on the communication bus, it can be suitable for acting on the first and second conditioning modules to enable/disable them;
in case of the last option, a first sum of the first time offset and a first propagation time of the first signal in the first conditioning module added to a second sum of the second time offset and a second propagation time of the digital signal representative of a second signal in the second conditioning module can be less than half a period of the communication protocol;
also in the presence of the latter option, it may comprise a first signal detector arranged to detect each first signal supplied by the input/output interface, and a second signal detector arranged to detect each signal supplied by the second conditioning module. For example, the first and second signal detectors may each comprise a monostable multivibrator;
also in the presence of the latter option, it may comprise at least one first comparator introducing the first time offset, and at least one second comparator introducing the second time offset;
alternatively, in the second embodiment it can comprise a controller arranged to detect each first signal and each second signal, and to enable/disable the transmitting stage and receiving stage;
in the presence of the latter option, the controller can be arranged to enable/disable the first conditioning module and the second conditioning module;
also in the case of the latter option, the controller can be arranged to introduce the first and second time offsets.

The invention also proposes an access point comprising an input/output interface suitable for connection to a communication bus using a communication protocol, a transmitting stage suitable for converting a first signal from the input/output interface into a transmitted light signal, a receiving stage suitable for converting a received light signal into a second signal passed on to the input/output interface, and a control device of the type presented above.

For example, this access point can be part of a Light Fidelity (or LiFi) optical wireless network.

The invention will be better understood with the aid of the following description, given solely by way of example and with reference to the appended drawings in which:

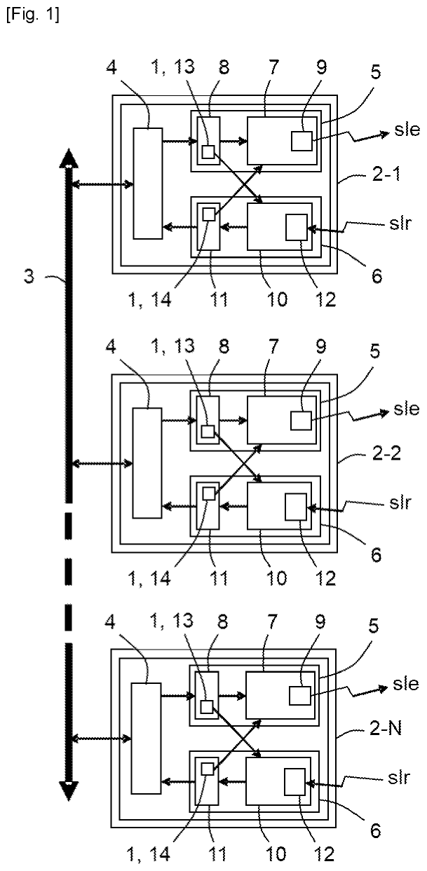

FIG. 1 illustrates schematically and functionally an example of a communication bus of an optical wireless communication network to which examples of access points are connected, each comprising a first embodiment of a control device according to the invention,

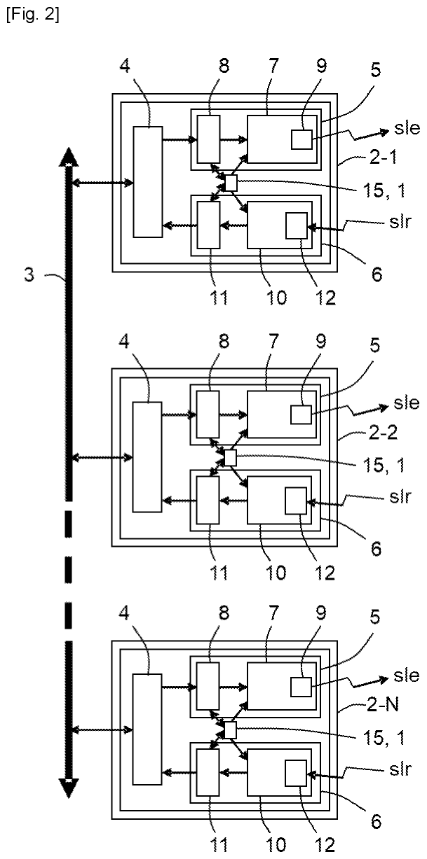

FIG. 2 illustrates schematically and functionally an example of a communication bus of an optical wireless communication network to which examples of access points are connected, each comprising a second embodiment of a control device according to the invention,

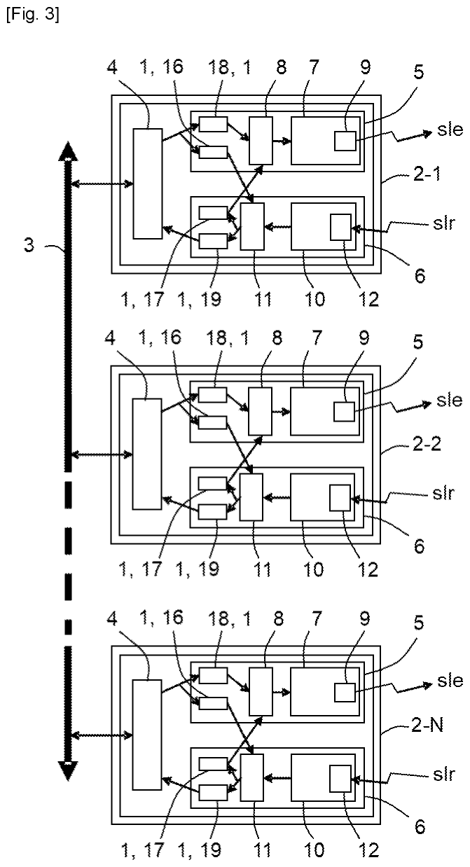

FIG. 3 illustrates schematically and functionally an example of a communication bus of an optical wireless communication network to which examples of access points are connected, each comprising a third embodiment of a control device according to the invention, and

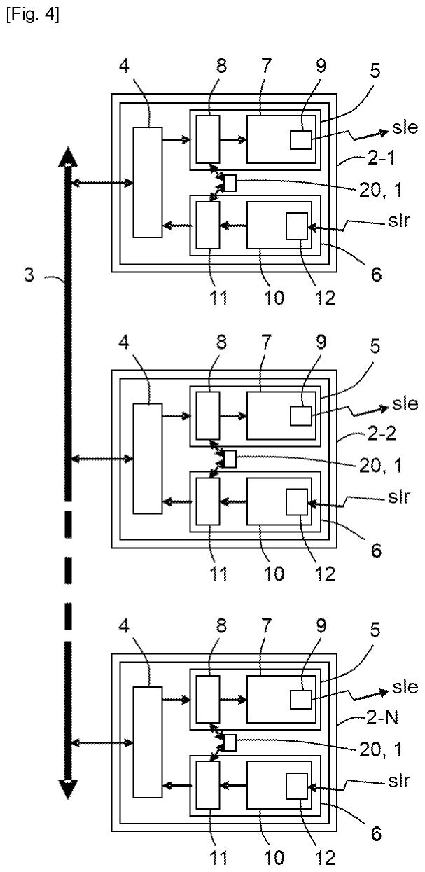

FIG. 4 illustrates schematically and functionally an example of a communication bus of an optical wireless communication network to which examples of access points are connected, each comprising a fourth embodiment of a control device according to the invention.

One of the purposes of the invention is to provide a control device 1 intended to form part of an access point 2-n (n=1 à N), itself intended to equip a communication bus 3 of an optical wireless communication (or OWC) network. N can take any value greater than or equal to one. For example, N can be between ten and thirty.

In the following, it is assumed that the optical wireless communication network is of the Light Fidelity (or LiFi) type. However, the invention is not limited to this type of optical wireless communication (or OWC) network. It concerns any type of optical wireless communication network based on time and/or frequency multiplexing.

As illustrated in FIGS. 1 to 4, each access point 2-n, connected to the communication bus 3, comprises at least one input/output interface 4, a transmitting stage 5, a receiving stage 6 and a control device 1 according to the invention.

The input/output interface 4 is bidirectionally connected to the communication bus 3, which uses a selected communication protocol, such as CANBUS or MIL-STD-1553.

The transmitting stage 5 is designed to convert a first signal s1 from the input/output interface 4 into a light signal sle transmitted to at least one piece of communications equipment (not shown) to which an OWC interface device (usually an accessory (or dongle)) is coupled. For example, a piece of communication equipment could be a cell phone (possibly smart (or smartphone)), a tablet computer, a computer (possibly a laptop), a sensor, an on-board computer, or any other piece of communications equipment that can be connected to the communication bus 3.

The receiving stage 6 is able to convert a received light signal slr (from a communication device, via an OWC interface device) into a second signal s2, which it passes on to the input/output interface 4.

The control device 1, according to the invention, is arranged either to disable the receiving stage 6 when the input/output interface 4 receives a first signal s1 from the communication bus 3, and to enable the receiving stage 6 when the input/output interface 3 no longer receives a first signal s1 from the communication bus 3, or to disable the transmitting stage 5 when the receiving stage 6 receives a light signal, and to enable the transmitting stage 5 when the receiving stage 6 no longer receives a light signal.

In other words, when an access point 2-n has to transmit a light signal sle, its receiving stage 6 is disabled to prevent it from receiving this same light signal sle, after reflection(s), and when an access point 2-n receives a light signal slr, its transmitting stage 5 is disabled to prevent it from re-transmitting this light signal slr. This limits, or even prevents, the probability of loops and therefore disturbances to the operation of communication bus 3.

For example, and as illustrated non-limitatively in FIGS. 1 to 4, the transmitting stage 5 of an access point 2-n may comprise a transmitting optoelectronic module 7 suitable for converting a digital signal sn derived from a first signal s1 into a light signal sle, and possibly a first conditioning module 8 interposed between the input/output interface 4 and this transmitting optoelectronic module 7 and suitable for shaping this first signal s1 (from the input/output interface 4) so that it is compatible with a voltage level that is admissible by the transmitting optoelectronic module 7.

The transmitting optoelectronic module 7 comprises at least one light source 9 responsible for generating the intensity- and/or frequency-modulated light signals sle representative of the data to be transmitted. This light source 9 may, for example, comprise at least one light-emitting diode (or LED) or at least one laser diode or at least one Vertical Cavity Surface-Emitting Laser (or VCSEL) diode.

The transmitting optoelectronic module 7 is responsible for carrying out the above-mentioned modulation and injecting the current required for data transmitting by the light source 9. It is in this transmitting optoelectronic module 7 that the electrical power supplied to light source 9 for data transmission is adjusted according to various constraints (maximum and minimum optical transmitting distances and power consumption, for example). Modulation and injection are provided by what is sometimes referred to as an AFE (“Analog Front-End”) device by those skilled in the art, which may include the light source 9 (as illustrated but not limited to).

Also by way of example, and as illustrated non-limitatively in FIGS. 1 to 4, the receiving stage 6 of an access point 2-n may comprise a receiving optoelectronic module 10 suitable for converting a received light signal slr into a digital signal sn which is representative of a second signal s2 (to be transmitted to the input/output interface 4), and possibly a second conditioning module 11 interposed between the receiving optoelectronic module 10 and the input/output interface 4 and suitable for shaping the digital signal sn supplied by the receiving optoelectronic module 10 so that the resulting second signal s2 can be interpreted on the communication bus 3.

The receiving optoelectronic module 10 comprises at least one photoreceiver 12 responsible for capturing (or receiving) the light signals slr in order to convert them into an electrical signal of the current (or photocurrent) type. This photoreceiver 12 may, for example, comprise at least one photodiode or at least one avalanche photodiode or at least one Single-Photon Avalanche Diode (SPAD).

The receiving optoelectronic module 10 is responsible for filtering and amplifying the photocurrent delivered by photoreceiver 12, which generally has a very low amplitude (typically a few mV at most). It is in this receiving optoelectronic module 10 that reception sensitivity and dynamic range can be adjusted. Filtering and amplification are provided by an AFE (Analog Front-End) device, which may optionally include the photoreceiver 12 (as illustrated non-limitatively).

At least two embodiments can be envisaged for the control device 1. These two embodiments are described below with reference to FIGS. 1 and 2 and FIGS. 3 and 4 respectively.

In a first embodiment illustrated in FIGS. 1 and 2, the control device 1 can be arranged either to disable the receiving optoelectronic module 10 when the input/output interface 4 receives a first signal s1 from the communication bus 3, and to enable the receiving optoelectronic module 10 when the input/output interface 4 no longer receives a first signal s1 from the communication bus 3, or to disable the transmitting optoelectronic module 7 when the receiving stage 6 receives a light signal slr, and to enable the transmitting optoelectronic module 7 when the receiving stage 6 no longer receives a light signal slr. It is therefore the transmitting optoelectronic module 7 and the receiving optoelectronic module 10 that are enabled or disabled as required.

For example, and as shown non-limitatively in FIG. 1, the control device 1 may comprise first 13 and second 14 signal detectors.

The first signal detector 13 is arranged to detect each first signal s1 (from the input/output interface 4) in the first conditioning module 8 and to enable/disable the receiving optoelectronic module 10 as required. It will be understood that when the first signal detector 13 detects a first signal s1 in the first conditioning module 8, it triggers the disabling of the receiving optoelectronic module 10, for example by transmitting to it a dedicated signal with a first value, and when the first signal detector 13 no longer detects a first signal s1 in the first conditioning module 8, it triggers the enabling of the receiving optoelectronic module 10, for example by transmitting to it this dedicated signal but with a second value. As shown non-limitatively in FIG. 1, the first signal detector 13 can be installed in the first conditioning module 8.

The second signal detector 14 is arranged to detect each digital signal sn supplied by the receiving optoelectronic module 10 in the second conditioning module 11 and to enable/disable the transmitting optoelectronic module 7 as required. It will be understood that when the second signal detector 14 detects a digital signal sn in the second conditioning module 11, it triggers the disabling of the transmitting optoelectronic module 7, for example by transmitting to it a dedicated signal having a first value, and when the second signal detector 14 no longer detects a digital signal sn in the second conditioning module 11, it triggers the enabling of the transmitting optoelectronic module 7, for example by transmitting to it this dedicated signal but with a second value. As shown non-limitatively in FIG. 1, the second signal detector 14 can be installed in the second conditioning module 11.

By way of example, the first 13 and second 14 signal detectors may each comprise a monostable multivibrator.

In a non-limiting embodiment illustrated in FIG. 2, the control device 1 may, for example, comprise a controller 15 which is arranged to detect each first signal s1 and each digital signal sn, and to enable/disable the transmitter stage 5 and receiver stage 6 as required.

For example, this controller 15 can be arranged to enable/disable the transmitting optoelectronic module 7 and receiving optoelectronic module 10 as required.

Also by way of example, and as illustrated non-limitatively in FIG. 2, this controller 15 can be external to the transmitting stage 5, receiving stage 6, first conditioning module 8 and second conditioning module 11, while being coupled to the latter four (5, 6, 8, 11). More specifically, it must be coupled to at least two of the four aforementioned elements, at least one on the transmitting side and at least one on the receiving side, all four of which may be connected.

It will be noticed that the controller 15 comprises at least one processor (or processing unit) and at least one memory cooperating together. The processor (or processing unit) may, for example, be a digital signal processor (or DSP). The memory stores data files and computer program(s) whose instructions are intended to be executed by the processor (or processing unit). This memory may, for example, be RAM (“Random Access Memory”), but it could be of another type. This processor and memory are arranged to perform detection and enabling/disabling operations together within their access point 2-n. The controller 15 may also comprise an input interface for receiving at least the first signals s1 and digital signals sn for use in calculations or processing, possibly after shaping and/or demodulating and/or amplifying them, in a manner known per se, by means of a digital signal processor. In addition, this controller 15 may also comprise an output interface, in particular for delivering enabling/disabling messages, and/or a mass memory. This controller 15 can, for example, be implemented in the form of a combination of electrical or electronic circuits or components (or “hardware”), possibly micro-programmed or micro-wired, software modules (or “software”), FPGA-type integrated circuits (“Field Programmable Gate Array”) and specialized integrated circuits (or ASIC (“Application-Specific Integrated Circuit”)).

In a second embodiment illustrated in FIGS. 3 and 4, the control device 1 can be arranged to introduce a first time offset dt1 of each first signal s1 into the transmitting stage 5, and a second time offset dt2 of each second signal s2 into the receiving stage 6, before it reaches the input/output interface 4. The first time offset dt1 is greater than or equal to a first duration dd1 required for disabling the receiving stage 6 and compatible with the communication protocol. The second time offset dt2 is greater than a second duration dd2 required to disable the transmitting stage 5 and compatible with the communication protocol.

This second embodiment is used when the time taken by a light signal sle emitted by an access point 2-n to return to the latter (2-n) is shorter than the second duration dd2 required for disabling the receiving stage 6, and/or when the duration of internal processing and propagation of a signal sn, s2 resulting from a received light signal slr is shorter than the first duration dd1 required for disabling the transmitting stage 5. This guarantees that there will be no interference or echoes between the transmitting stage 5 and the receiving stage 6, despite the high sensitivity of the latter (6), but also that the latencies introduced (notably by internal propagations) will not create too great an offset in relation to the communication speeds and latencies imposed by the various protocols.

In this second embodiment, the control device 1 may, for example, be able to act on (“enable/disable”) the first 8 and second 11 conditioning modules. In this case, the first sum ps of the first time shift dt1 and a first propagation time tp1 of the first signal s1 in the first conditioning module 8 added to the second sum ss of the second time shift dt2 and a second propagation time tp2 of the digital signal sn representative of a second signal s2 in the second conditioning module 11 is preferably less than half the period (T/2) of the communication protocol of the communication bus 3 (i.e., ps (=dt1+tp1)+ss (=dt2+tp2)<T/2, with dt1>dd2 and dt2>dd1). For example, if the communication protocol operates at 1 MHz, then T/2=500 ns, and therefore ps+ss<500 ns. This is the case, for example, when dd1=dd2=100 ns, dt1=dt2=180 ns and tp1=tp2=18 ns (it can be verified that then ps+ss=(180+18)*2=396 ns<500 ns.

For example, and as shown non-limitatively in FIG. 3, the control device 1 may comprise first 16 and second 17 signal detectors.

The first signal detector 16 is arranged to detect each first signal s1 (from the input/output interface 4) and to enable/disable the second conditioning module 11 as required. It will be understood that when the first signal detector 16 detects a first signal s1 downstream of the input/output interface 4, it triggers the disabling of the second conditioning module 11, for example by transmitting to it a dedicated signal having a first value, and when the first signal detector 16 no longer detects a first signal s1 downstream of the input/output interface 4, it triggers the enabling of the second conditioning module 11, for example by transmitting to it this dedicated signal but with a second value. As shown non-limitatively in FIG. 3, the first signal detector 16 can be installed upstream of the first conditioning module 8 and receives the first signal s1 supplied by the input/output interface 4 at its access point 2-n.

The second signal detector 17 is arranged to detect each second signal s2 supplied by the second conditioning module 11 and to enable/disable the first conditioning module 8 as required. It will be understood that when the second signal detector 17 detects a second signal s2 supplied by the second conditioning module 11, it triggers the disabling of the first conditioning module 8, for example by transmitting to it a dedicated signal having a first value, and when the second signal detector 17 no longer detects a second signal s2 supplied by the second conditioning module 11, it triggers the enabling of the first conditioning module 8, for example by transmitting to it this dedicated signal but with a second value. As shown non-limitatively in FIG. 3, the second signal detector 17 can be installed downstream of the second conditioning module 11 and receives the second signal s2 supplied by the latter (11).

By way of example, the first 16 and second 17 signal detectors may each comprise a monostable multivibrator.

Also, by way of example, and as illustrated non-limitatively in FIG. 3, the control device 1 may comprise at least one first comparator 18 introducing the first time offset dt1, and at least one second comparator 19 introducing the second time offset dt2.

As shown non-limitatively in FIG. 3, the first comparator 18 can be installed upstream of the first conditioning module 8 and receives the first signal s1 supplied by the input/output interface 4 at its access point 2-n, which it delays in order to communicate it to the first conditioning module 8 with the first time offset dt1. Also as shown in FIG. 3, the second comparator 19 can be installed downstream of the second conditioning module 11 and receives the second signal s2 supplied by the latter (11), which it delays in order to communicate it to the input/output interface 4 with the second time offset dt2.

The use of comparators 18, 19 is particularly interesting when the time offsets dt1, dt2 to be introduced are typically greater than a hundred nanoseconds. When the time offsets dt1, dt2 to be introduced are less than a hundred nanoseconds, they can be implemented by “lower-level” analog electronics (typically transistors and filters) coupled with a routing technique enabling the propagation times of the various signals to be controlled, so as to enable finer adjustment of the enabling times (for example, by adjusting the lengths of the tracks propagating the signals).

In a non-limiting embodiment illustrated in FIG. 4, the control device 1 may, for example, comprise a controller 20 which is arranged to detect each first signal s1 and each second signal s2, and to enable/disable the transmitting stage 5 and receiving stage 6 as required.

For example, this controller 20 can be arranged to enable/disable the first conditioning module 8 and second conditioning module 11 as required.

Also, by way of example, and as illustrated non-limitatively in FIG. 4, this controller 20 may be external to the transmitting stage 5, receiving stage 6, first conditioning module 8 and second conditioning module 11, while being coupled to the latter two (8, 11).

Also, for example, the controller 20 can be arranged to introduce the first dt1 and second dt2 time offsets, which is possible if signals s1 and s2 pass through this controller 20, which is then not limited solely to detecting signals s1 and s2.

It will be noticed that the controller 20 comprises at least one processor (or processing unit) and at least one memory cooperating together. The processor (or processing unit) may, for example, be a digital signal processor (or DSP). The memory stores data files and computer program(s) whose instructions are intended to be executed by the processor (or processing unit). This memory may, for example, be of the RAM type, but it could be of another type. This processor and this memory are arranged to perform detection and enabling/disabling operations together within their access point 2-n. The controller 20 may also comprise an input interface for receiving at least the first signals s1 and second signals s2 for use in calculations or processing, possibly after shaping and/or demodulating and/or amplifying them, in a manner known per se, by means of a digital signal processor. In addition, this controller 20 may also include an output interface, in particular for delivering enabling/disabling messages, and/or a mass memory. This controller 20 can, for example, be implemented in the form of a combination of electrical or electronic circuits or components (or hardware), possibly micro-programmed or micro-wired, software modules (or software), FPGA-type integrated circuits and specialized integrated circuits (or ASICs).

The use of a controller 20 significantly increases flexibility thanks to global, centralized management of all propagation times (and in particular time offsets dt1 and dt2) and real-time communication speeds, as well as real-time enabling/disabling, since the origin of signals and data is known at all times.

It should also be noticed that the invention is not limited to the above-described embodiments. Indeed, it will be apparent to those skilled in the art that various modifications can be made to the embodiments described above, in the light of the teaching just disclosed. In the detailed presentation of the invention given above, the terms used should not be interpreted as limiting the invention to the embodiments set out in the present description, but should be interpreted to include all equivalents the anticipation of which is within the reach of those skilled in the art by applying their general knowledge to the implementation of the teaching just disclosed to them.

1. A control device for an access point comprising an input/output interface connected to a communication bus using a communication protocol, a transmitting stage adapted to convert a first signal from said input/output interface into a transmitted light signal, and a receiving stage adapted to convert a received light signal into a second signal passed on to said input/output interface,
wherein the control device is arranged either to disable said receiving stage when said input/output interface receives a first signal from said communication bus, and to enable said receiving stage when said input/output interface no longer receives a first signal from said communication bus, or to disable said transmitting stage when said receiving stage receives a light signal, and to enable said transmitting stage when said receiving stage no longer receives a light signal.

2. The control device according to claim 1, wherein in the presence of an access point comprising a transmitting stage including a transmitting optoelectronic module adapted to convert a digital signal derived from a first signal into a light signal, and a receiving stage including a receiving optoelectronic module adapted to convert a received light signal into a digital signal representative of a second signal, the control device is arranged either to disable said receiving optoelectronic module when said input/output interface receives a first signal from said communication bus, and to enable said receiving optoelectronic module when said input/output interface no longer receives a first signal from said communication bus, or to disable said transmitting optoelectronic module when said receiving stage receives a light signal, and to enable said transmitting optoelectronic module when said receiving stage no longer receives a light signal.

3. The control device according to claim 2, wherein in the presence of an access point comprising a transmitting stage including a first conditioning module interposed between said input/output interface and said transmitting optoelectronic module and adapted to shape said first signal so that it is compatible with a voltage level admissible by said transmitting optoelectronic module, and a receiving stage including a second conditioning module interposed between said receiving optoelectronic module and said input/output interface and adapted to shape said digital signal supplied by said receiving optoelectronic module so that said resulting second signal can be interpreted on said communication bus, it the control device comprises a first signal detector arranged to detect each first signal in said first conditioning module and to enable/disable said receiving optoelectronic module, and a second signal detector arranged to detect each digital signal supplied by said receiving optoelectronic module in said second conditioning module and to enable/disable said transmitting optoelectronic module.

4. The control device according to claim 2, comprising a controller arranged to detect each first signal and each digital signal, and to enable/disable said transmitting stage and receiving stage.

5. The control device according to claim 2, comprising a controller arranged to detect each first signal and each digital signal, and to enable/disable said transmitting stage and receiving stage, wherein said controller is arranged to enable/disable said transmitting optoelectronic module and receiving optoelectronic module.

6. The control device according to claim 1, wherein the control device is arranged to introduce into said transmitting stage a first time offset of each first signal greater than or equal to a first duration required for disabling said receiving stage and compatible with said communication protocol, and to introduce into said receiving stage a second time offset of each second signal before it reaches said input/output interface, said second time offset being greater than a second duration required for disabling said transmitting stage and compatible with said communication protocol.

7. The control device according to claim 6, wherein in the presence of an access point comprising a transmitting stage including a transmitting optoelectronic module suitable for converting adapted to convert a digital signal derived from a first signal into a light signal, and a first conditioning module interposed between said input/output interface and said transmitting optoelectronic module and adapted to shape said first signal so that it is compatible with a voltage level admissible by said transmitting optoelectronic module, and a receiving stage comprising a receiving optoelectronic module adapted to convert a received light signal into a digital signal representative of a second signal, and a second conditioning module interposed between said input/output interface and said receiving optoelectronic module and adapted to shape said digital signal supplied by said receiving optoelectronic module so that said resulting second signal can be interpreted on said communication bus, it is able to act on said first and second conditioning modules to enable/disable them.

8. The control device according to claim 7, wherein a first sum of said first time offset and a first propagation time of said first signal in said first conditioning module added to a second sum of said second time offset and a second propagation time of said digital signal representative of a second signal in said second conditioning module is less than half a period of said communication protocol.

9. The control device according to claim 7, comprising a first signal detector arranged for detecting each first signal supplied by said input/output interface, and a second signal detector arranged for detecting each signal supplied by said second conditioning module.

10. The control device according to claim 3, wherein said first and second signal detectors each comprise a monostable multivibrator.

11. The control device according to claim 6, comprising at least one first comparator introducing said first time offset, and at least one second comparator introducing said second time offset.

12. The control device according to claim 7, comprising a controller arranged to detect each first signal and each second signal, and to enable/disable said transmitting stage and receiving stage.

13. The control device according to claim 12, wherein said controller is arranged to enable/disable said first conditioning module and second conditioning module.

14. The control device according to claim 6, comprising a controller arranged to detect each first signal and each second signal, and to enable/disable said transmitting stage and receiving stage, wherein said controller is arranged to introduce said first and second time offsets.

15. An access point comprising an input/output interface suitable for connection to a communication bus using a communication protocol, a transmitting stage adapted to convert a first signal from said input/output interface into a transmitted light signal, and a receiving stage adapted to convert a received light signal into a second signal passed on to said input/output interface, and a control device according to claim 1.

16. The access point according to claim 15, adapted to form part of a Light Fidelity optical wireless network.
